(19) United States
(12) Patent Application Publication
(10) Pub. No.: US 2003/0049401 A1
(43) Pub. Date: Mar. 13, 2003

(54) Low permeation nitrile-butadiene rubber tube with aluminum barrier layer

(76) Inventors: Jeremy Duke, Lexington, TN (US); Jerry Shifman, Wildersville, TN (US)

Correspondence Address: DAYCO PRODUCTS, LLC, 1 PRESTIGE PLACE, MIAMISBURG, OH, 45342, US

(21) Appl. No.: 09/951,312

(22) Filed: Sep. 13, 2001

(51) Int. Cl. B32B 1/08

(52) U.S. Cl. 428/36.91

(57) ABSTRACT

A flexible fuel transport hose having improved fuel vapor permeation characteristics comprising an inner layer of a conductive nitrile-butadiene rubber, a thin aluminum barrier layer on the outside surface of the inner tubular layer, and an elastomeric adhesive layer on the outer surface of the aluminum layer; and a method for making the flexible fuel transport hose are disclosed.

### BACKGROUND OF THE INVENTION

The present invention relates to the field of tubular structures, and particularly to the field of flexible tubular structures used in the automotive industry as fuel and vapor transmission tubes which have reduced permeability to fuel and vapor. More particularly, the invention relates to flexible nitrile-butadiene rubber fuel transport tubes which have a thin aluminum barrier layer, and to the use of such fuel transport hoses to reduce the amount of fuel vapor released to the atmosphere from motor vehicles.

Recent environmental regulations imposed on the automotive and on the fuel delivery industries severely limit the amount of fuel vapor that can permeate from the fuel system of motor vehicles and from the fuel delivery hoses used to transport such fuels. For example, these regulations require that all new automobiles sold in states where this regulation are in effect must pass a vehicle permeation test designated as the S.H.E.D TEST, which measures the emissions, i.e., fuel vapors, from a motor vehicle with the engine not running. Under this regulation, a maximum of 2 grams of vapor emission per 24 hours period is allowable. Such emissions are those permeating from the fuel hoses and any other parts of the fuel supply system.

Choosing the right combination of materials to be used in the construction of fuel transport hoses, such as fuel filler hoses and fuel filler neck hoses, to provide high performance, long service life and low permeability of fuel vapor in the hose, while maintaining manufacturing costs at an acceptable level has been more difficult than ever before. Typically, fuel transfer hoses have been constructed of elastomeric materials such as butadiene-acrylonitrile rubber or the like, but such hoses have a high permeability to fuel. Other hoses have a fluoroelastomer as the inner wall surface layer of the hose, but such hoses also have a high permeability to fuel vapor. Attempts to produce fuel transport hoses with reduced permeability to fuel vapors have included the use of corrugated polyamide and fluorocarbon thermoplastic tubes. However, these structures are presently considered to be only marginally effective to reduce the permeability of fuel vapors while being relatively expensive.

Other attempts to produce a fuel hose with reduced permeability to fuel vapors use a tetrafluoroethylene-hexafluoropropylene-vinylidine fluoride terpolymer liner and a thicker layer of hexafluoropropylene-vinylidine fluoride copolymer or other suitable elastomer as the conductive inner part of the tube. For example, such hoses are discussed in U.S. Pat. No. 4,606,952 to Sugimoto and U.S. Pat. No. 5,430,603 to Albino et al. Such hose structures though have a tendency to wrinkle on the inner radius of the forming mandrel or pin causing an undesirable and discernable defect which may also exhibit a weakened area in the hose.

A number of prior art patents disclose flexible hoses incorporating metallic layers of one type or another. Such disclosures appear, for example, in U.S. Pat. Nos. 318,458 to Fletcher; U.S. Pat. No. 4,559,793 to Hane et al.; U.S. Pat. No. 4,758,455 to Campbell et, al.; U.S. Pat. No. 5,182,147 to Davis; U.S. Pat. No. 5,271,977 to Yoshikawa et al.; U.S. Pat. No. 5,360,037 to Lindstrom; and U.S. Pat. No. 5,398,729 to Spurgat.

Commonly assigned U.S. Pat. No. 6,074,717 to Little et al. discloses a flexible hose containing an inner tube constructed of a conductive ethylene-propylene diene polymethylene (EPDM), an aluminum barrier layer and an EPDM outer layer. The tubular structure may contain a reinforcing layer. The tubular structure is vulcanized in place using a peroxide. The tubular structure is used to transport fluids in a radiant heating system. U.S. Pat. Nos. 4,779,673 and 5,488,975 to Chiles et al. also disclose flexible hoses used for circulation of fluids in radiant heating systems in houses and businesses. For example, Chiles U.S. Pat. No. 5,488,975 discloses a flexible heating system hose having an inner layer of EPDM, a fabric reinforcing layer, a fill layer, a thin barrier layer which may be polyvinyl alcohol (PVOH) or aluminum around the fill layer, and a cover such as polyvinyl chloride (PVC).

U.S. Pat. No. 5,476,121 to Yoshikawa et al teaches a low permeable rubber hose having a barrier layer of silver or silver alloy formed by wet plating or dry plating with ion plating or sputtering. None of these art references teach a flexible fuel hose having an aluminum barrier layer bonded to a conductive NBR inner tube and to an elastomeric adhesion layer which might serve as a cover, wherein the rubber layers are vulcanized to prevent delamination. Therefore, an urgent need exists for a flexible fuel hose which prevents permeation of fuels and which prevents delamination under stress over long periods of time.

### SUMMARY OF THE INVENTION

The present invention provides a flexible tube constructed for use in fuel systems to prevent permeation of fuel vapor into the environment. The flexible tube has a thin layer of aluminum sandwiched between a conductive nitrile-butadiene rubber (NBR) inner tubular structure and an outer elastomeric adhesive layer which could serve as a cover for the flexible tube. Acrylonitrile is a synthetic rubber made by random polymerization of acrylonitrile with butadiene in the presence of a free radical catalyst. Since the acrylonitrile component of the acrylonitile-butadiene rubber is important for fuel resistance, the higher the acrylonitrile component in the NBR, the more fuel resistant is the tube manufactured in accordance with the invention.

The conductive nitrile-butadiene rubber (NBR) tubular structure contains an agent which imparts conductivity to the NBR. Typically, the conductive agent is elemental carbon, but may be any conductive agent or combination of conductive agents commonly recognized in the industry to provide conductivity to a rubber or plastic material. Examples of such conductive agents include elemental carbon, copper, silver, gold, nickel, and alloys of such metals. Preferably, the conductive agent is elemental carbon which is commonly referred to as carbon black.

The elastomeric rubber adhesive layer of the present invention may be used as an outer cover for the tube. The elastomeric rubber adhesive layer can be formed from any of the materials commonly employed as an outside cover material for fuel tubes. Typically, such material include, but are not limited to, chlorinated polyethylene; Hypalon®, a synthetic chlorosulfonated polyethylene available from Du Pont; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.

In accordance with the invention, the inner NBR tubular structure and the outer elastomeric adhesive layer are adhered to the aluminum to prevent delamination. In one embodiment, the inner NBR tubular structure and the elastomeric rubber adhesive layer are adhered to the aluminum using a suitable polyolefin or modified-polyolefin material which can be successfully used as an adhesive layer at the elevated temperatures necessary to extrude the tubes of the present invention. An anhydride-modified linear low density polyethylene available from Du Pont under the name Bynel® and from Mitsui under the name Admer® has been found to be satisfactory in adhering the aluminum layer to either or both of the adjacent layers. In another embodiment of the invention, the inner NBR tubular structure and the elastomeric rubber adhesive layer, are vulcanized in place against corresponding surfaces of the aluminum layer to provide sufficient adhesion and thereby prevent delamination of the layers. The vulcanizing agents employed are those typically use in vulcanizing such elastomeric materials.

### BRIEF DESCRIPTION OF THE DRAWINGS

FIG. 1 is a perspective view of the invention in its simplest form comprising only an aluminum barrier layer sandwiched between an NBR inner tube and an elastomeric adhesive outer layer;

FIG. 2 is an end view of the fuel tube of FIG. 1;

FIG. 3 is a perspective view of a fuel tube illustrating another aspect of the invention;

FIG. 4 is an end view of the fuel tube of FIG. 3;

FIG. 5 is a perspective view of a fuel tube illustrating still another aspect of the invention;

FIG. 6 is an end view of the fuel tube of FIG. 5;

FIG. 7 is a perspective view of a fuel tube illustrating yet another aspect of the invention;

FIG. 8 is an end view of the fuel tube of FIG. 7;

FIG. 9 is a perspective view of a fuel tube illustrating another aspect of the invention; and

FIG. 10 is an end view of the fuel tube of FIG. 9

### DETAILED DESCRIPTION OF THE INVENTION

In accordance with the invention, a flexible fuel transport hose is provided which not only meets the present low permeability standard, but also exhibits increased resistance to delamination during extended use.

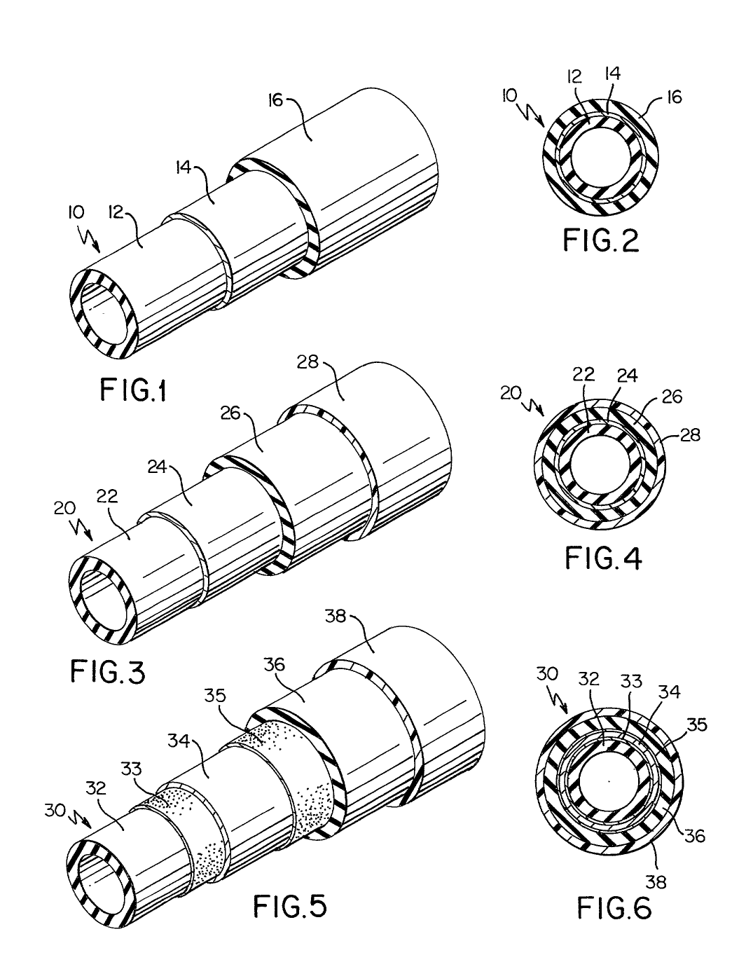

A simple flexible hose manufactured in accordance with the present invention is illustrated in FIGS. 1 and 2, wherein a flexible fuel hose 10 has an inner tubular structure 12 comprising nitrile-butadiene rubber (NBR), a thin aluminum barrier layer 14 surrounding the outermost surface of the NBR tubular structure 12, and an elastomeric adhesive tubular structure 16 adjacent to and surrounding the outermost surface of the aluminum barrier layer 14.

FIGS. 3 and 4 illustrate another flexible fuel tube 20 made in accordance with the invention. The tube 20 comprises an NBR inner tubular structure 22, a thin aluminum barrier layer 24, an elastomeric adhesive tubular structure 26, and a cover layer 28.

FIGS. 5 and 6 illustrate still another flexible fuel tube made in accordance with the invention. The hose 30 comprises an NBR inner tubular structure 32, a first adhesive layer 33, a thin aluminum barrier layer 34, a second adhesive layer 35, and elastomeric tubular structure 36, and a cover layer 38.

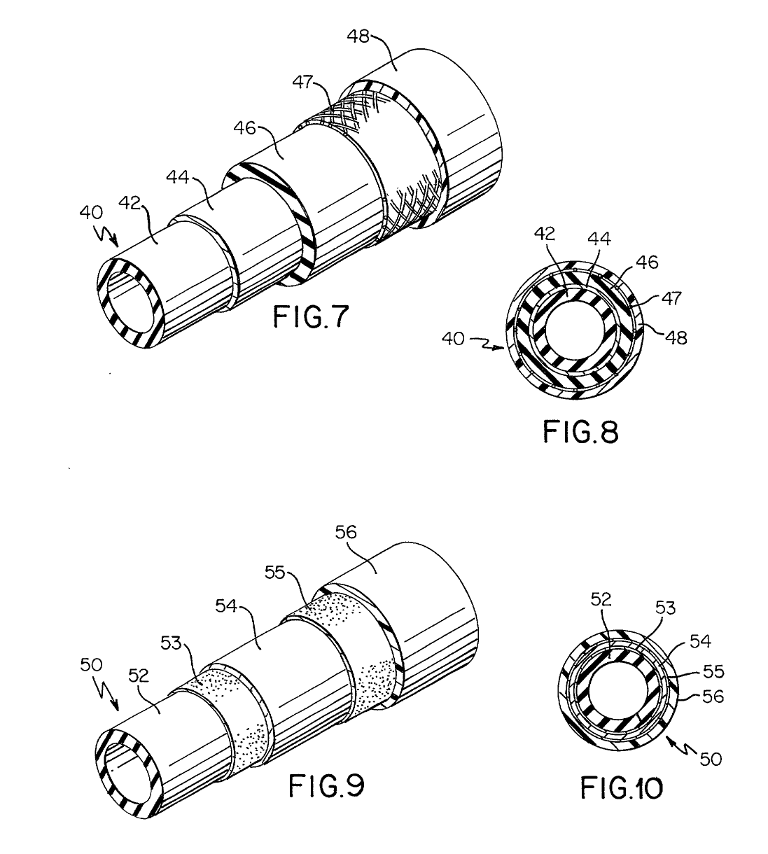

FIGS. 7 and 8 illustrate yet another flexible fuel tube made in accordance with the invention. The hose 40 comprises an NBR inner tubular structure 42, a thin aluminum barrier layer 44, an elastomeric tubular structure 46, a reinforcement layer 47, and a cover layer 48.

FIGS. 9 and 10 illustrate another flexible fuel tube 50 which comprises a first adhesive layer 53 disposed between the NBR inner tubular structure 52 and the aluminum barrier layer 54; and a second adhesive layer 55 disposed between the aluminum barrier layer 54 and the elastomeric tubular structure 56.

It has been found that the tubes of the present invention show a remarkable advantage over prior art fuel transfer tubes in significantly reducing the permeation of fuel vapor as well as providing for extended tube life fuel to the unique combination and tubular structure wherein the inner tubular structure is a nitrile-butadiene rubber (NBR). The thickness of the NBR tubular structure can range from about 0.5 to 2.5 mm. Preferably, the thickness of the NBR tubular structure is about 0.75 to 1.75 mm. While the nitrile component of the NBR does not appear to be particularly critical, fuel hoses containing NBR having a nitrile content of about 32 to 45 percent have been found to be especially useful in carrying out the invention.

As is common practice in the industry, the inner NBR layer of the fuel hoses of the present convention is made conductive to prevent the build up of static electricity generated by the flow of fuel along the inner surface of the hose. Typically, the inner NBR tubular structure is made conductive by compounding the NBR with one or more industry recognized ingredients such as carbon black to provide conductivity to the inner NBR layer. While the amount of carbon black in the inner NBR tube is not critical, the amount should be sufficient to provide effective conductivity, but not in excessive amounts which tend to make the NBR difficult to process. Amounts of carbon black in the range of about 15 to 35 percent have been found effective in carrying out the invention.

Typically, the aluminum barrier layer is a thin layer of aluminum having a thickness of about 0.02 to 1 mm. In a preferred aspect of the invention, the inner NBR tubular structure is wrapped by a layer of aluminum foil. This may be accomplished by helical wrapping or by tensioned radial curling. Alternatively, a thin layer of aluminum may be deposited around the outer surface of the inner NBR tubular structure by electrolytic deposition.

The third or outer tubular structure of the hose of the present invention comprises an elastomeric adhesive layer such as chlorinated polyethylene; chlorosulfonated polyethylene, such as Hypalon manufacture by Du Pont; styrene-butadiene rubber (SBR); butadiene-nitrile rubber, for example, butadiene-acrylonitrile rubber; nitrile-polyvinyl chloride; EPDM, neoprene; vinylethylene-acrylic rubber, acrylic rubber; epichlorohydrin rubber, such as Hydrin 200, a copolymer of epichlorohydrin and ethylene oxide, available from Du Pont; polychloroprene rubber; polyvinyl chloride; ethylene-propylene copolymers ultra high molecular weight polyethylene; high density polyethylene; chlorobutyl rubber, or the like; and blends thereof. Preferably, the outer cover is a chlorinated polyethylene. The particular material selected as the outer tubular structure should be chosen according to the environmental condition the hose is expected to encounter. Typically, a thickness of about 0.6 to 2.5 mm is sufficient for the outer tubular layer and, preferably, the thickness is about 1.0 to 1.5 mm.

The fuel transfer hose of the present invention comprising a thin aluminum layer sandwiched between a nitrile-butadiene rubber inner tubular structure and an elastomeric adhesive layer is vulcanized in place using one or more of any of the art recognized vulcanizing agents such as peroxides, polyols, polyamide, etc. The peroxide vulcanizing agent includes, for example, dicumylperoxide; 2,5-dimethyl-2,5-di (t-butylprroxy) hexyne-3; etc. The polyols vulcanizing agent includes, for example, hexafluoropropylidene-bis (4-hydroxyphenyl) hydroquinone, isopropylidene-bis (4-hydroxyphenyl) hydroquinone or the like. The polyamine vulcanizing agent includes, e.g., hexamethybutadiene carbonate, alicyclic diamine carbonate, etc. The amount of vulcanizing agent employed is generally that which is customarily used in the art. Typically, about 0.5 to 10% vulcanizing agent is employed depending on the vulcanizing agent. The vulcanizing agent(s) is generally mixed into the compounds when the compounds are originally formulated.

It may be desirable to adhere the various layers to one another using a tie layer. The particular tie layer or adhesive used can be any of those known in the art and which will adhere to the specific material employed and to the aluminum layer. For example, Bynel® and Admer®, both of which are an anhydride-modified linear low density polyethylene commercially available from Du Pont and Mitsui, respectively, have proven to be satisfactory adhesives for use in the present invention. The tie layer or adhesive may be applied by methods commonly employed in the art.

It is also within the concept of the present invention to include a reinforcing layer. Typically, the reinforcing layer is a fabric braid which is wound closely around the elastomeric adhesive layer and provides a reinforcing mesh constructed, e.g., of a plurality of filaments or fibers which are interwoven in a grid structure. The fabric braid enhances the structural integrity of the hose and increases its pressure and puncture resistance. Among the types of materials that may be used for the fibers are rayon, nylon, polyester, wire, aramid material or any other type of suitable polyester reinforcing material.

In addition to the reinforcing layer, a fill layer comprising an elastomer may be applied over the reinforcing mesh to flow into and substantially fill the grid openings in the reinforcing layer.

When a reinforcing layer is employed, a protective cover is typically extruded or otherwise applied over the reinforcing layer to protect the interior components of the hose from abrasion and from adverse effects caused by chemicals to which the hose may be exposed. Preferably, the cover is in the form of a thin walled tube and is typically constructed of chlorinated polyethylene (CPE), nitrile, nitrile-PVC, EPDM, neoprene, hypalon, chlorobutyl, styrene-butadiene rubber (SBR), butadiene-nitrile rubber such as butadiene-acrylonitrile rubber, chlorosulfonated polyethylene, vinyl ethylene-acrylic rubber acrylic rubber, epichlorohydrin rubber polychloroprene rubber, polyvinyl chloride (PVC), ethylene-propylene copolymers, high density polyethylene (HDPE) ultra high molecular weight polyethylene (UHMWPE) and blends thereof.

The method of producing the fuel transfer hose of the present invention comprises forming a first nitrile-butadiene rubber (NBR) tubular structure, wrapping a thin layer of aluminum foil around the outer surface of the NBR tubular structure by helical wrapping or by tensional radial curling or by any other method by which the aluminum foil can be applied around the NBR tubular structure. Another method for applying the aluminum layer or the NBR tubular structure is by electrolytic deposition.

The elastomer's rubber adhesive layer can be applied around the aluminum coated NBR tubular structure by extrusion techniques known in the art.

Other additives such as antioxidants, processing aids, etc., can be employed in amounts and methods known in the art.

Having described the invention in detail and by reference to preferred embodiments thereof, it will be apparent to those skilled in the art that modifications and variations are possible without departing from the scope of the invention defined in the appended claims.

What is claimed is:

1. A flexible fuel transport tube having improved fuel vapor permeation, said tube comprising:
an inner nitrile-butadiene rubber (NBR) tubular structure;
a thin layer of aluminum disposed on the outer surface of said inner nitrile-butadiene rubber (NBR) tubular structure; and
an elastomeric rubber adhesive layer disposed on the outer surface of said thin layer of aluminum.

2. The tube of claim 1, wherein said inner nitrile-butadiene rubber tubular structure, and said elastomeric rubber adhesive layer are vulcanized in place against said aluminum layer to prevent delamination thereof.

3. The tube of claim 1, wherein said inner nitrile-butadiene rubber (NBR) tubular structure has a wall thickness of about 0.5 to 02.5 mm.

4. The tube of claim 1, wherein said thin aluminum layer has a thickness of about 0.02 to 1.5 mm.

5. The tube of claim 1, wherein said elastomeric adhesive layer has a wall thickness of about 0.06 to 0.25 mm.

6. The tube of claim 1, wherein said elastomeric rubber adhesive layer is selected from the group consisting of chlorinated polyethylene; chlorosulfonated polyethylene; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.

7. The tube of claim 2, wherein said inner nitrile-butadiene rubber tubular structure and said elastomeric rubber layer are vulcanized using a vulcanizing agent selected from the group consisting of one or more peroxides, polyols and polyamines.

8. The tube of claim 7, wherein said vulcanizing agent is dicumylperoxide, 2,5-dimethyl-2,5-di (t-butylperoxy) hexyne-3, hexafluoroisopropylidine-bis (4-hydroxyphenyl hydroquinone, isopropylidene-bis di-(4-hydroxyphenyl) hydroquinone, hexamethylene-diamine carbamate or alicyclic amine carbarnate.

9. The tube of claim 7, wherein said vulcanizing agent is present in an amount of about 0.5 to 3 weight percent.

10. The tube of claim 1, wherein said inner nitrile-butadiene rubber tubular structure further includes a conductive material incorporated therein.

11. The tube of claim 10, wherein said conductive material is (a) elemental carbon or (b) a metal selected from the group consisting of copper, silver, gold, nickel, and alloys thereof.

12. The tube of claim 10, wherein said conductive material is elemental carbon.

13. The tube of claim 1, further comprising at least one intermediate tie layer disposed between said inner nitrile-butadiene rubber tubular structure and said thin aluminum layer and/or between said thin aluminum layer and said elastomeric rubber adhesive layer.

14. The tube of claim 13, wherein said intermediate adhesive layer is an anhydride-modified linear low density polyethylene.

15. The tube of claim 1, further comprising a reinforcing layer surrounding the outer surface of said elastomeric rubber adhesive layer.

16. The tube of claim 13, wherein said reinforcing layer comprises rayon, nylon, polyester, wire or polyamide.

17. The tube of claim 13, further comprising a protective cover layer surrounding said reinforcing layer.

18. The tube of claim 15, wherein said protective cover layer comprises chlorinated polyethylene; chlorosulfonated polyethylene; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.

19. A flexible fuel transport tube having improved fuel vapor permeation, said tube comprising:
an inner nitrile-butadiene rubber (NBR) tubular structure having a wall thickness of about 0.5 to 2.5 mm;
a first intermediate adhesive layer disposed on the outer surface of said inner nitrile-butadiene rubber tubular structure;
a thin layer of aluminum having a wall thickness of about 0.02 to 1.5 mm disposed on the outer surface of said first intermediate adhesive layer;
a second intermediate adhesive layer disposed on the outer surface of said thin aluminum layer; and
an elastomeric rubber adhesive layer having a wall thickness of about 0.02 to 0.25 mm disposed on the outer surface of said second intermediate adhesive layer, said elastomeric rubber adhesive layer being selected from the group consisting of chlorinated polyethylene; chlorosulfonated polyethylene; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.

20. A method of making a flexible fuel transfer tube having improved fuel vapor permeation, said method comprising the steps of:
providing a conductive nitrile-butadiene rubber (NBR) tubular structure;
applying a thin layer of aluminum to the outer surface of said nitrile-butadiene rubber; and
applying an elastomeric rubber adhesive layer to the outer surface of said aluminum layer

21. The method of claim 19 further including the step of vulcanizing said nitrile-butadiene rubber tubular structure and said elastomeric adhesive layer in place against said layer of aluminum.

22. The method of claim 19, wherein said nitrile-butadiene rubber tubular structure has a wall thickness of about 0.5 to 2.5 mm.

23. The method of claim 19, wherein said layer of aluminum has a thickness of about 0.02 to 1.5 mm.

24. The method of claim 19, wherein said elastomeric adhesive layer or selected from the group consisting of chlorinated polyethylene (CPE), nitrile, nitrile-PVC, EPDM, neoprene, hypalon, chlorobutyl, styrene-butadiene rubber, chlorosulfonated polyethylene, vinyl ethyleneacrylic rubber, acrylic rubber, epichlorohydrin rubber, polychloroprene rubber, polyvinyl chloride (PVC) ethylene-propylene copolymer, high density polyethylene, ultra high molecular weight polyethylene and blends thereof.

25. The method of claim 19, wherein said elastomeric adhesive layer has a thickness of about 0.02 to 0.25 mm.

26. The method of claim 20, wherein said rubber layers are vulcanized using a vulcanizing agent selected from the group consisting of one or more peroxides, polyols and polyamines.

27. The method of claim 21, wherein said vulcanizing agent is dicumylperoxide, 2,5-dimethyl-2,5-di (t-butylperoxy) hexyne-3, hexafluoroisopropylidine-bis (4-hydroxyphenyl) hydroquinone, isopropylidene-bis (4-hydroxyphenyl) hydroquinone, hexamethylene-diamine carbamate or alicyclic diamine carbamate.

28. The method of claim 26, wherein said vulcanizing agent is present in an amount of about 0.5 to 3 weight percent.

29. The method of claim 19, wherein a conductive material is incorporated into said nitrile-butadiene rubber.

30. The method of claim 28, wherein said conductive material is (a) elemental carbon or (b) a metal selected from the group consisting of copper, silver gold, nickel, and alloys thereof.

31. The method of claim 28, wherein said conductive material is elemental carbon

32. The method of claim 19, further including the step of providing a reinforcing layer on the outer surface of said elastomeric rubber adhesive layer.

33. The method of claim 31, wherein said reinforcing layer comprises rayon, nylon, polyester, wire, or polyamide.

34. The method of claim 31, further comprising a protective cover surrounding said reinforcing layer.

35. The method of claim 33, wherein said protective cover layer comprises chlorinated polyethylene; chlorosulfonated polyethylene; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.

36. A method of making a flexible fuel transfer tube having improved fuel vapor permeation, said method comprising the steps of:
providing an inner nitrile-butadiene rubber (NBR) tubular structure having a wall thickness of about 0.5 to 2.5 mm;
applying a first intermediate adhesive layer onto the outer surface of said inner nitrile-butadiene rubber tubular structure;
applying a thin layer of aluminum having a wall thickness of about 0.02 to 1.5 mm onto the outer surface of said first intermediate adhesive layer;
applying a second intermediate adhesive layer onto the outer surface of said thin aluminum layer; and
applying an elastomeric rubber adhesive layer having a wall thickness of about 0.02 to 0.25 mm onto the outer surface of said second intermediate adhesive layer, said elastomeric rubber adhesive layer being selected from the group consisting of chlorinated polyethylene; chlorosulfonated polyethylene; styrene-butadiene rubber; butadiene-nitrile rubber; nitrile-polyvinyl chloride; EPDM, neoprene; vinylethylene-acrylic rubber; acrylic rubber; epichlorohydrin rubber; copolymers of epichlorohydrin and ethylene oxide; polychloroprene rubber; polyvinyl chloride; ethylene-propylene copolymers; ultra high molecular weight polyethylene; high density polyethylene; chlorobutyl rubber; and blends thereof.
